(19) United States
(12) Patent Application Publication
(10) Pub. No.: US 2006/0096638 A1
(43) Pub. Date: May 11, 2006

(54) Chemical delivery system for condensate drain tray of an air conditioner

(76) Inventor: Gregory Coogle, Pembroke Pines, FL (US)

Correspondence Address: YI LI, CUSPA TECHNOLOGY LAW ASSOCIATES, 11820 SW 107 AVENUE, MIAMI, FL, 33176, US

(21) Appl. No.: 10/982,573

(22) Filed: Nov. 5, 2004

(51) Int. Cl. G05D 7/00

(52) U.S. Cl. 137/268

(57) ABSTRACT

A chemical delivery system for an air conditioner includes an elongated reservoir body having an open upper end, a closed lower end and having a central cavity; a tubular connector having a first end connected perpendicularly to the reservoir body, and connection means at a second end for connecting to the condensate drain tray of the air conditioner; a basket disposed within the central cavity; and a cap connected to the open upper end of the reservoir body to close the central cavity. The basket has an elongated basket body having an open upper end, a closed lower end, and a plurality of apertures disposed around a middle portion of the basket body for providing a fluid communication between inside and outside of the basket. A growth inhibition chemical placed inside the basket releases through the tubular connector into the condensate drain tray.

### FIELD OF THE INVENTION

The present invention relates to a chemical delivery system for the condensate drain tray of air conditioners, which dispenses chemicals to inhibit microbial growth.

### BACKGROUND OF THE INVENTION

The condensation of water in air conditioning equipments requires the constant collection and disposal of water through drainage pipes or lines. The water standing still encourages the growth of microbials, such as algae, bacteria and other organisms that clog the pipes. Various designs for chemical delivery systems have been designed in the past.

U.S. Pat. No. 5,976,364 (to Williams) discloses an apparatus for treating air conditioner condensate with algicide. The apparatus provides dissolving biotic growth composition into air conditioner condensate fluid. The apparatus includes a housing for holding the inhibitor and a container, located within the housing. The container allows contact between the inhibitor and condensate while retaining undissolved inhibitor in the housing. Williams' device relies on moving parts, and it cannot use liquid chemicals, as they would be washed out with the condensate.

U.S. Pat. No. 6,651,690 B1 (to Coogle) discloses a chemical delivery system having an inlet and an outlet for connecting in the drain line downstream of the condensate drain tray to dispense chemicals into the drain line. This device is not used for connecting to the condensate drain tray to control microbial growth in the tray.

It is preferred to control microbial growth in the condensate drain tray, because it is the starting point of the condensate drainage system. Any growth in the tray can become the seed for growth in the downstream drain line. Currently, there are solid tablets available for placing into the condensate drain tray. However, direct contact of concentrate chemicals with the tray can be corrosive. Furthermore, one can not use liquid chemicals in the tray, because the chemicals will be washed out by the condensate water.

Therefore, there exists a need for chemical delivery system suitable for dispensing growth control chemicals, either liquid or solid, to the condensate drain tray.

### SUMMARY OF THE INVENTION

In one embodiment, the present invention is directed to a chemical delivery system for an air conditioner, which comprises an elongated reservoir body having an open upper end, a closed lower end, and a central cavity; a tubular connector having a first end connected perpendicularly to the reservoir body, and connection means at a second open end for connecting to a drainage system of the air conditioner; the tubular connector being in fluid communication with the central cavity; a basket removably disposed within the central cavity; and a top cap removably connected to the open upper end of the reservoir body for closing the central cavity. The basket has an elongated basket body having an open upper end, a closed lower end, and a plurality of apertures disposed around a middle portion of the basket body for providing a fluid communication between inside and outside of the basket.

The upper portion of the reservoir body can have the same geometry and dimension as the other parts of the reservoir body. Alternatively, the upper portion of the reservoir body and the upper portion of the basket body can also have a funnel shape with enlarged openings for facilitating liquid dispense.

In a further embodiment, the chemical delivery system can have an open lower end and a bottom cap removably connected to the open lower end, which eases the cleaning of the reservoir body when desired. The chemical delivery system can further include a liquid level sensor in the tubular connector to sense potential damaging water level caused by drain line clogging.

### BRIEF DESCRIPTION OF THE DRAWINGS

FIG. 1 is a perspective view of a chemical delivery system of one embodiment of the present invention.

FIG. 2 is a sectional side view of the chemical delivery system of FIG. 1.

FIG. 3 is an exploded view of the chemical delivery system of FIG. 1.

FIG. 4 is an enlarged perspective view of the basket of the chemical delivery system shown in FIG. 1.

FIG. 5 is a sectional side view of a chemical delivery system of FIG. 1, with incorporation of a liquid level sensor in the tubular connector.

FIG. 6 is a sectional side view of a chemical delivery system of a further embodiment of the present invention, wherein the upper portion of the reservoir body and the upper portion of the basket body have a funnel shape.

FIG. 7 is a sectional side view of a chemical delivery system of another embodiment of the present invention, which has a bottom cap removably connected to the lower open end.

FIG. 8 is a partially exploded view showing the connection of the chemical delivery system of FIG. 1 with a condensate drain tray.

It is noted that the like parts are labeled by the like numbers throughout the drawings.

### DETAILED DESCRIPTION OF THE INVENTION

In one embodiment, the present invention provides a chemical delivery system for controlling microbial growth inside condensate drain tray of an air conditioner and downstream thereof.

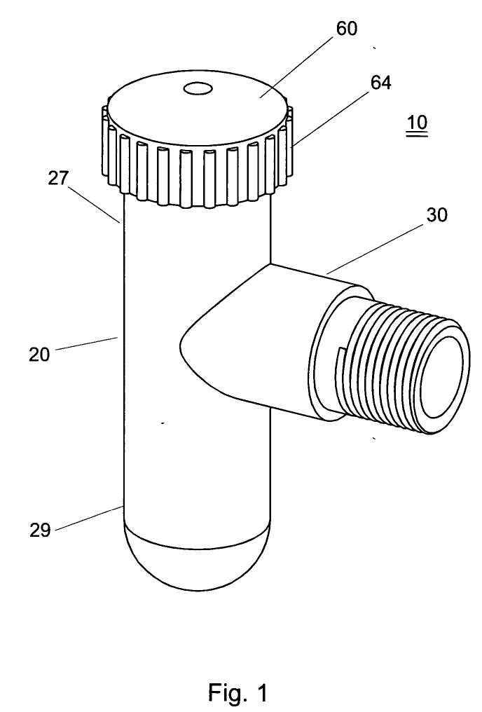

Referring now to FIGS. 1-4, a chemical delivery system 10 comprises an elongated reservoir body 20, a tubular connector 30, a basket 40 and a top cap 60. As shown, elongated reservoir body 20 has an open upper end 22, a closed lower end 24 and a central cavity 26. Tubular connector 30 has a first end 32 connected perpendicularly to elongated reservoir body 20, and connection means 36 at a second open end 34 for connecting chemical delivery system 10 to the condensate drain tray or other parts of the drainage system of an air conditioner. Basket 40 is disposed within central cavity 26. Top cap 60 is removably connected to open upper end 22 of elongated reservoir body 20 for closing central cavity 26.

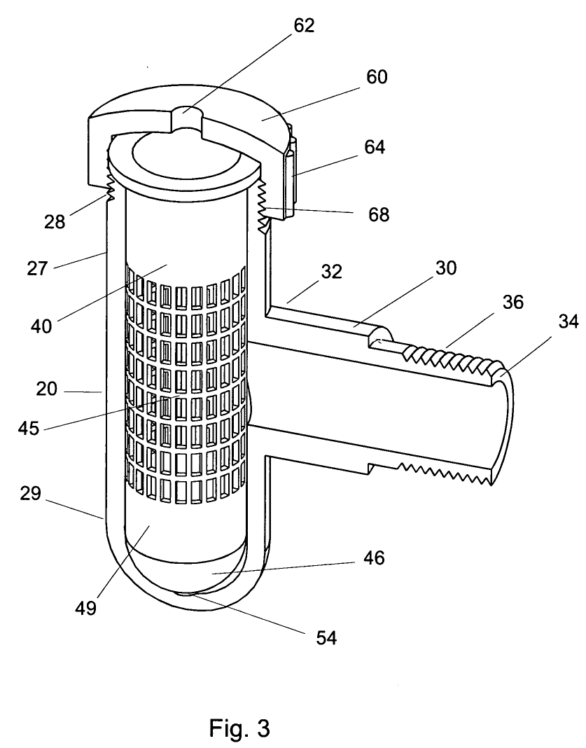

Basket 40 has an elongated basket body 42 which has an open upper end 44, a closed lower end 46, and a plurality of apertures 48 disposed around a middle portion 45 of elongated basket body 42. Preferably, middle portion 45 is more than one third of the total length of elongated basket body 42. Upon disposed within central cavity 26, the lower part of middle portion 45 extends vertically below tubular connector 30, and the upper part of middle portion 45 extends vertically above tubular connector 30, as shown in FIG. 3. The liquid inside basket 40 is in fluid communication with condensate water in condensate drain tray.

As shown in FIGS. 1-4, both elongated reservoir body 20 and elongated basket body 42 have a tubular shape. It should be understood that other suitable shapes can also be used for elongated reservoir body 20 and elongated basket body 42. In general, the outer shape of elongated basket body 42 and the dimension thereof are complementary to the inner shape of elongated reservoir body 20 and the dimension thereof to provide a tight surface contact between lower portion 49 of elongated basket body 40 and lower portion 29 of elongated reservoir body 20. The tight surface contact functions to prevent debris from the condensate drain tray falling between basket 40 and low portion 29 of elongated reservoir body 20. Instead, debris enters into basket 40 through apertures 48, and descends down to closed lower end 24. When needed, the user can take out basket 40 through open upper end 22 to discard debris accumulated inside and to clean basket 40 without the need to disconnect chemical delivery system 10 from the condensate drain tray for cleaning.

Preferably, the outer dimension of closed lower end 46 of basket 40 is complementary to the inner dimension of closed lower end 24 of reservoir body 20, to reduce the potential for debris accumulation in between. In the embodiment shown, closed lower ends 24 and 46 are semispherical. However, closed lower ends 24 and 46 can also have other suitable shapes and geometries. Optionally, basket 40 can further comprise a nipple 54 protruding from closed lower end 46, for preventing closed lower end 46 sticking on to the interior surface of closed lower end 24 by debris.

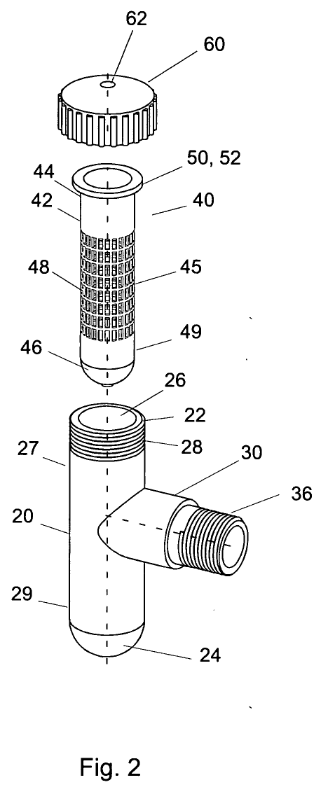

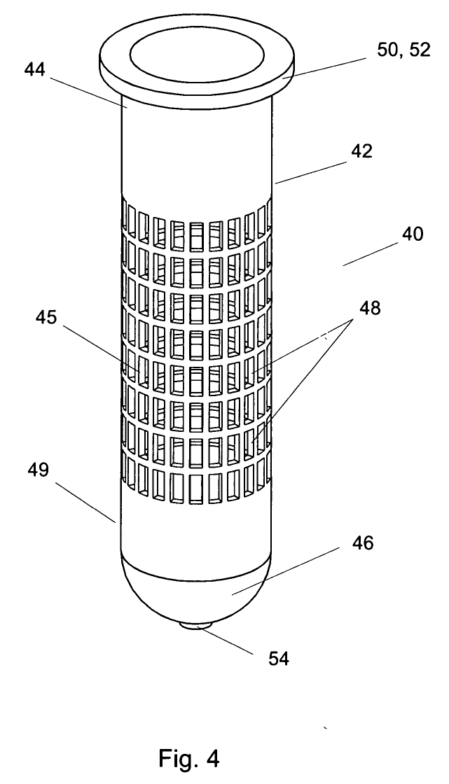

Furthermore, basket 40 can have retainer means 50 to maintain the vertical position of basket 40 within central cavity 26. In the embodiment shown in FIGS. 2 and 4, retainer means 50 is a periphery flange 52 around open upper end 44. When basket 40 is put into central cavity 26, periphery flange 52 sits on top of open upper end 22 of elongated reservoir body 20, which facilitates removal of basket 40 from chemical delivery system for cleaning, or refill.

The chemicals that can be placed in chemical delivery system 10 include liquid and solid forms of antimicrobials. Growth control tablets, such as Frost King Pan-Tablets manufactured by Thermwell Products, Co., Inc., New Jersey, can be conveniently dropped into basket 40. Any insoluble material from the tablet is accumulated inside basket 40, and can be easily cleaned as described above for cleaning the debris.

As shown in FIG. 3, top cap 60 has internal thread 68 complementary to external thread 28 of reservoir body 20 for closing central cavity 26. Top cap 60 is removed to deposit growth inhibiting chemicals and also for cleaning purposes. Preferably, on the external periphery of the top cap 60 there are gripping assistant means to help the user to grip the cap. As shown in FIG. 1, gripping assistant means are a plurality of protruding ridges 64 along the external periphery of the cap. Alternatively, the gripping assistant means can also be a plurality of grooves, or other suitable means.

Preferably, top cap 60 has a venting opening 62 as shown in FIGS. 1-3. Venting opening 62 assists to balance interior and exterior air pressure, which, in turn, maintains an equal water level in the condensate drain tray and in reservoir body 20.

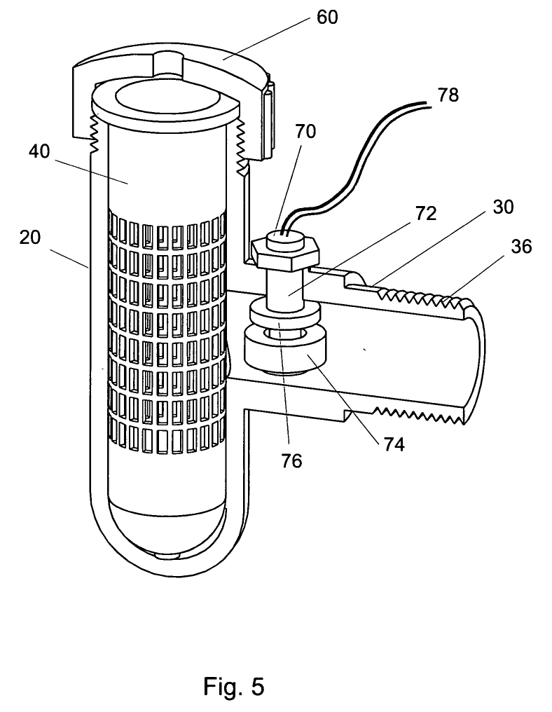

Chemical delivery system 10 can further include a liquid level sensor 70 disposed in the tubular connector for sensing water level increase caused by clogging of the drain line. Liquid level sensor 70 has a sensing portion disposed within tubular connector 30 between first end 32 and second end 34 and a connection portion 78 outside of tubular connector 30 for connecting to a control system. In the embodiment shown in FIG. 5, liquid level sensor 70 is a float sensor which includes a float 74 connected to the bottom of a stem 72, and a stop 76 disposed above float 74. Upon connecting chemical delivery system 10 to the condensate drain tray, the water level in chemical delivery system 10 is in equilibrium with the condensate water in the condensate drain tray. When the water level increases due to clogging of the drain line, float 74 lifts up along stem 72, causing engagement of two magnets embedded in float 74 and stem 72, which triggers a control system. The control system then can shut down the air conditioner to prevent damage of the air conditioning system. In addition to the float sensor, other suitable liquid level sensors can also be used for the chemical delivery system of the present invention.

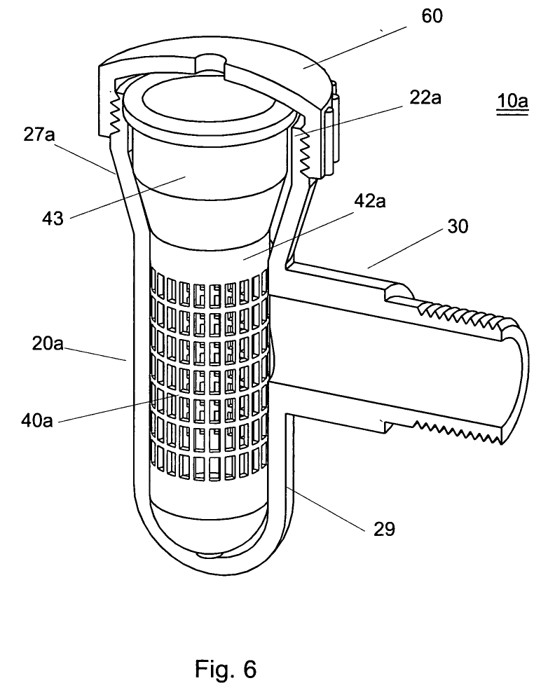

In an alternative embodiment as shown in FIG. 6, reservoir body 20a of chemical delivery system 10a has an upper portion 27a in a funnel shape with an enlarged open upper end 22a. In this embodiment, the basket body 42a of basket 40a has an enlarged upper portion 43, complementary to the inner shape of upper portion 27a of reservoir body 20a. The funnel shape structure facilitates addition of a liquid chemical, such as chlorine, into the central cavity.

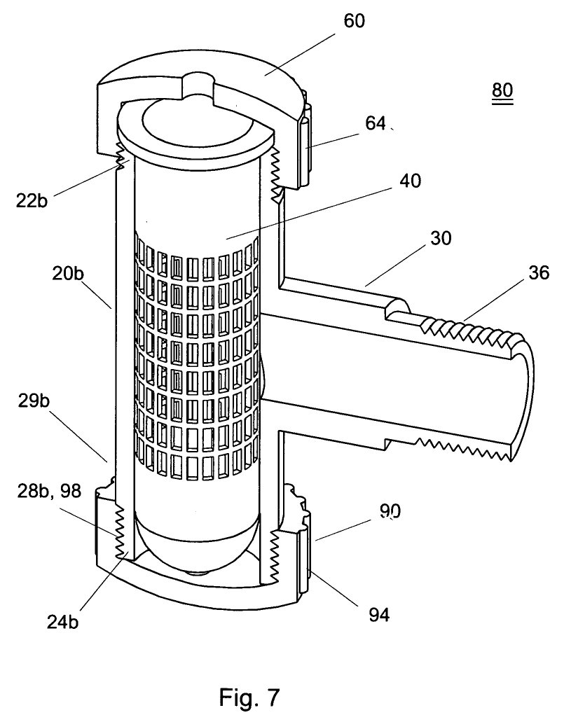

In a further embodiment as illustrated in FIG. 7, chemical delivery system 80 has an elongated reservoir body 20b which has an open lower end 24b, and a bottom cap 90 connected to open lower end 24b. On the exterior surface around open lower end 24 there is an external thread 28b for engaging with complementary internal thread 98 of bottom cap 90 to provide a fluid tight connection. Similar to top cap 60 described previously, bottom cap 90 has a plurality of protruding ridges 94 along the external periphery of the cap to assist the user to grip the cap. With this open lower end structure, lower portion 29b of reservoir body 20b can be easily cleaned. When it is desired, the user can remove top cap 60, bottom cap 90, and basket 40 from reservoir body 20b, and use a water hose to flush reservoir body 20b from open upper end 22b.

It is noted that the structure of the other parts of reservoir body 20b, tubular connector 30 and top cap 60 of chemical delivery system 80 are the same as those corresponding components of chemical delivery system 10 described previously.

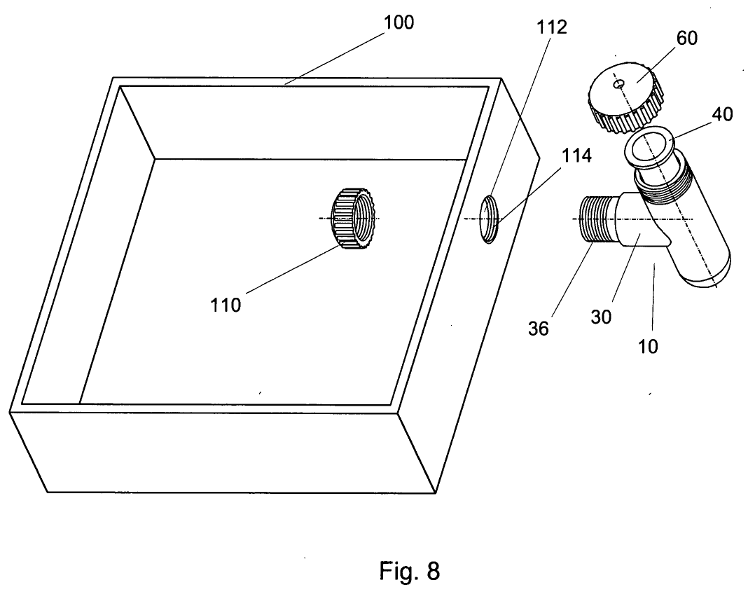

In the embodiments shown in FIGS. 1-3 and 5-8, connection means 36 are external thread which can be complementary to the internal thread 114 of openings 112 present on the sides of the condensate drain tray 100, as shown in FIG. 8. The openings 112 are provided with standard condensate drain trays for connecting pipes. Alternatively, chemical delivery system 10, 10a, or 80 can be connected to a condensate drain tray by inserting a portion of tubular connector 30 through opening 112 on the side of the condensate drain tray 100 and then fastening it by a nut 110. Other suitable connection means can also be used for connecting the chemical delivery system to the condensate drain tray.

Once chemical delivery system 10, 10a or 80, connects to the condensate drain tray, condensate water will enter into the chemical delivery system, and the water level will be in equilibrium between the condensate drain tray and the chemical delivery system. If the antimicrobial placed in the chemical delivery system is solid tablets, it dissolves gradually. The antimicrobial in the chemical delivery system will enter into condensate drain tray by diffusion, which can control the growth of microbials, particularly algae, in the tray and downstream drain line. Liquid chemicals function in the same way. Using the chemical delivery system of the present invention, one does not need to add concentrate chemicals directly into the condensate drain tray, which can be corrosive to the tray. Furthermore, the instant chemical delivery system also provides a time release mechanism for dispensing a small amount of antimicrobials for long term control and maintenance.

Reservoir bodies 20, 20a and 20b, tubular connector 30, baskets 40 and 40a, top cap 60 and bottom cap 90 are preferably injection molded of a plastic material, such as polyethylene, polyvinyl chloride (PVC), and polyamide.

It is noted that although chemical delivery systems 10, 10a, or 80 of the present invention are to be connected to the condensate drain tray for growth control inside the condensate drain tray, chemical delivery system 10 can also be connected to downstream air conditioner drainage system for preventing clogging of the drain line.

The invention has been described with reference to particularly preferred embodiments. It will be appreciated, however, that various changes can be made without departing from the spirit of the invention, and such changes are intended to fall within the scope of the appended claims. While the present invention has been described in detail and pictorially shown in the accompanying drawings, these should not be construed as limitations on the scope of the present invention, but rather as an exemplification of preferred embodiments thereof. It will be apparent, however, that various modifications and changes can be made within the spirit and the scope of this invention as described in the above specification and defined in the appended claims and their legal equivalents. All patents and other publications cited herein are expressly incorporated by reference.

I claim:

1. A chemical delivery system for an air conditioner, comprising:
an elongated reservoir body having an open upper end, a closed lower end and a central cavity;
a tubular connector having a first end connected perpendicularly to said reservoir body, and connection means at a second open end for connecting to a drainage system of said air conditioner; said tubular connector being in fluid communication with said central cavity;
a basket removably disposed within said central cavity; and
a top cap removably connected to said open upper end of said reservoir body for closing said central cavity.

2. The chemical delivery system of claim 1, wherein said basket has an elongated basket body having an open upper end, a closed lower end, and a plurality of apertures disposed around a middle portion of said basket body for providing a fluid communication between inside and outside of said basket.

3. The chemical delivery system of claim 2, wherein an outer shape of a lower portion of said elongated basket body and dimension thereof are complementary to an inner shape of a lower portion of said reservoir body and dimension thereof to provide a tight surface contact between said lower portions.

4. The chemical delivery system of claim 2, wherein said basket further comprises a nipple protruding from said closed lower end of said elongated basket body.

5. The chemical delivery system of claim 2, wherein said basket further comprises retainer means to maintain a vertical position of said basket within said central cavity.

6. The chemical delivery system of claim 5, wherein said retainer means is a periphery flange around said open upper end of said basket body for hanging said flange on top of said open upper end of said reservoir body.

7. The chemical delivery system of claim 1, wherein an upper portion of said reservoir body and an upper portion of said basket body are enlarged for facilitating addition of a liquid chemical into said central cavity.

8. The chemical delivery system of claim 1, wherein said drainage system of said air conditioner is a condensate drain tray.

9. The chemical delivery system of claim 8, wherein said connection means of said tubular connector is an external thread.

10. The chemical delivery system of claim 1, wherein said tubular connector further comprises a liquid level sensor having a sensing portion disposed within said tubular connector between said first and second ends and a connection portion outside of said tubular connector for connecting to a control system.

11. A chemical delivery system for an air conditioner, comprising:
an elongated reservoir body having an open upper end, an open lower end and a central cavity;
a tubular connector having a first end connected perpendicularly to said reservoir body, and connection means at a second open end for connecting to a drainage system of said air conditioner; said tubular connector being in fluid communication with said central cavity;
a basket removably disposed within said central cavity;
a top cap removably connected to said open upper end of said reservoir body for closing said open upper end; and
a bottom cap removably connected to said lower open end of said reservoir body for closing said lower open end.

12. The chemical delivery system of claim 11, wherein said basket has an elongated basket body having an open upper end, a closed lower end, and a plurality of apertures disposed around a middle portion of said basket body for providing a fluid communication between inside and outside of said basket.

13. The chemical delivery system of claim 12, wherein an outer shape of a lower portion of said elongated basket body and dimension thereof are complementary to an inner shape of a lower portion of said reservoir body and dimension thereof to provide a tight surface contact between said lower portions.

14. The chemical delivery system of claim 12, wherein said basket further comprises a nipple protruding from said closed lower end of said elongated basket body.

15. The chemical delivery system of claim 12, wherein said basket further comprises retainer means to maintain a vertical position of said basket within said central cavity.

16. The chemical delivery system of claim 15, wherein said retainer means is a periphery flange around said open upper end of said basket body for hanging said flange on top of said open upper end of said reservoir body.

17. The chemical delivery system of claim 11, wherein an upper portion of said reservoir body and an upper portion of said basket body are enlarged for facilitating addition of a liquid chemical into said central cavity.

18. The chemical delivery system of claim 11, wherein said drainage system of said air conditioner is a condensate drain tray.

19. The chemical delivery system of claim 18, wherein said connection means of said tubular connector is an external thread.

20. The chemical delivery system of claim 11, wherein said tubular connector further comprises a liquid level sensor having a sensing portion disposed within said tubular connector between said first and second ends and a connection portion outside of said tubular connector for connecting to a control system.
